(19) United States
(12) Patent Application Publication
(10) Pub. No.: US 2006/0081343 A1
(43) Pub. Date: Apr. 20, 2006

(54) Retractable protective dome for space vehicle equipment

(76) Inventors: Paul R. Clark, San Diego, CA (US); Ross H. Messinger, Tustin, CA (US)

Correspondence Address: Don C. Lawrence;MacPHERSON KWOK CHEN & HEID LLP, Suite 226, 1762 Technology Drive, San Jose, CA, 95110, US

(21) Appl. No.: 10/969,829

(22) Filed: Oct. 20, 2004

(51) Int. Cl. E06B 3/12

(52) U.S. Cl. 160/218

(57) ABSTRACT

A retractable rigid dome for protecting a feature, such as a docking mechanism, a hatch or other equipment on an exterior surface of a space vehicle, includes a plurality of rigid arcuate segments, each having opposite ends respectively pinioned at opposite sides of the feature at about the surface of the vehicle for rotational movement about an axis of rotation extending through the opposite ends thereof and through an arcuate path of rotation extending over the feature. The radial sizes of the segments are staggered such that, in a fully deployed position of the dome, in which adjacent segments are rotated apart from each other at a maximum relative angle therebetween, the segments combine to form an arcuate shield over the feature, and in a retracted position of the dome, in which adjacent segments are rotated together at a common angle relative to the surface of the vehicle, the segments are nested in radial alignment with each other.

### RELATED APPLICATIONS

This application is related to U.S. application Ser. No. ______ [Attorney Docket No. M-15516 US], filed herewith, which is incorporated herein by reference in its entirety.

### SPONSORED RESEARCH OR DEVELOPMENT

The invention described herein was made in the performance of work under NASA Contract No. NAS8-01099 and is subject to the provisions of Section 305 of the National Aeronautics and Space Act of 1958 (72 Stat.435: 42 U.S.C. 2457).

### STATEMENT REGARDING FEDERALLY

### TECHNICAL FIELD

This invention relates to protective shields for space vehicles in general, and in particular, to telescopically retractable domes for providing thermal and micrometeoroid and orbital debris (“MMOD”) protection for docking mechanisms, hatches, and other equipment disposed on an exterior surface of a space vehicle, space station, space exploration habitat, and the like.

### BACKGROUND

The environment of space is harsh and can subject the equipment used on the exterior of space vehicles, space stations, and space exploration habitats, such as hatches, docking mechanisms, antennae, cameras, sensors and the like, to a wide variety of potentially harmful agents, including strong thermal radiation and micrometeoroid impacts. Consequently, it is frequently desirable to provide a protective shield over the affected equipment to ameliorate the damaging effects of such elements. Conventional space vehicle protective doors and shields are typically generally planar in shape and cantilevered to one side of the area of the affected equipment when disposed in an open position, and can therefore interfere with the openings that they close, or the equipment on the surface of the vehicle that they are intended to protect, such as a docking ring or an antenna.

Consequently, a long-felt but as yet unsatisfied need exists for a simple, reliable protective shield, or cover, that can be deployed over a docking mechanism, hatch, or other equipment used on the surface of a space vehicle to provide at least thermal and MMOD protection for the equipment, and that overcomes the disadvantages of conventional doors and shields as discussed above.

### BRIEF SUMMARY

In accordance an exemplary embodiment of the present invention, a simple, reliable, telescopically retractable dome is provided that can be deployed over a docking mechanism, hatch, or other equipment disposed on the surface of a space vehicle to provide at least thermal and MMOD protection for the equipment, and that is capable of being retracted substantially out of the way of the protected equipment when not in use, to avoid interference with access to and use of the equipment.

In an exemplary embodiment thereof, the protective dome comprises a plurality of rigid, arcuate segments subtended by a common angle, each having respective opposite ends respectively pinioned at opposite sides of the feature to be protected at about the surface of the vehicle for independent rotational movement of the segment about an axis extending through the opposite ends thereof, and through an arcuate path of revolution extending over the protected feature. Each of the rigid segments has a respective radial size that is arranged such that, in a deployed position of the dome, in which adjacent segments are rotated apart from each other at a maximum relative angle therebetween, the segments overlap at their respective edges, and combine with each other to form an arcuate shield over the protected feature that extends down to the surface of the vehicle. In a retracted position of the dome, in which adjacent segments are rotated together at a common angle relative to the surface of the vehicle, the segments are nested in a radial alignment with each other. Advantageously, the segments may comprise at least one of a thermal protection material and a micrometeoroid- and debris-resistant material, and a thermal seal may be disposed between adjacent segments to thermally insulate the feature more completely from ambient space when the dome is deployed over it.

In one exemplary embodiment, the arcuate segments each comprises a segment of a sphere, such that, in the deployed position, the dome is generally hemispherical in shape. In other embodiments, the segments may be polygonal in shape. In a “bi-fold” embodiment, the arcuate segments may comprise two groups, each defining a portion of the arcuate shield formed over the feature, which mate with each other at, e.g., a vertical plane extending through the feature when the dome is deployed. In this embodiment, an even number of segments is provided, half of which are grouped on one side of the protected feature, and the other half of which are grouped on an opposite side thereof.

In another advantageous embodiment, the protective dome may include a protective annular bezel having an internal diameter that is larger than the diameter of any of the segments, which is disposed on the surface of the vehicle and aligned generally concentrically with the feature, and the segments can be arranged to reside below an upper periphery of the bezel when the protective dome is in the fully retracted position.

A better understanding of the above and many other features and advantages of the present invention may be obtained from a consideration of the detailed description thereof below, particularly if such consideration is made in conjunction with the appended drawings, wherein like reference numerals are used to identify like elements illustrated in one or more of the figures.

### BRIEF DESCRIPTION OF THE DRAWINGS

FIG. 1A is a partial cross-sectional elevation view of a rigid protective dome in accordance with an exemplary embodiment of the present invention, shown in a retracted position over a feature on the surface of a space vehicle;

FIG. 1B is a partial cross-sectional elevation view of the protective dome of FIG. 1A, shown in a deployed position over the feature;

FIG. 2A is a partial cross-sectional elevation view of a rigid protective dome in accordance with another exemplary embodiment of the present invention, shown in a retracted position over a feature on the surface of a space vehicle;

FIG. 2B is a partial cross-sectional elevation view of the protective dome of FIG. 2A, shown in a deployed position over the feature;

FIG. 3A is a partial cross-sectional view of two adjacent arcuate segments of an exemplary embodiment of a rigid protective dome of the present invention, showing the segments rotated together at a common angle relative to the surface of the vehicle and radially aligned with each other;

FIG. 3B is a partial cross-sectional view of the two adjacent segments of FIG. 3A, showing the segments rotated apart at a maximum relative angle therebetween to form a portion of an arcuate protective shield over the feature;

FIGS. 4A-4C are perspective views of the protective dome of FIGS. 1A and 1B in closed, partially closed, and open positions, respectively; and,

FIGS. 5A-5C are perspective views of the protective dome of FIGS. 2A and 2B in closed, partially closed, and open positions, respectively.

### DETAILED DESCRIPTION

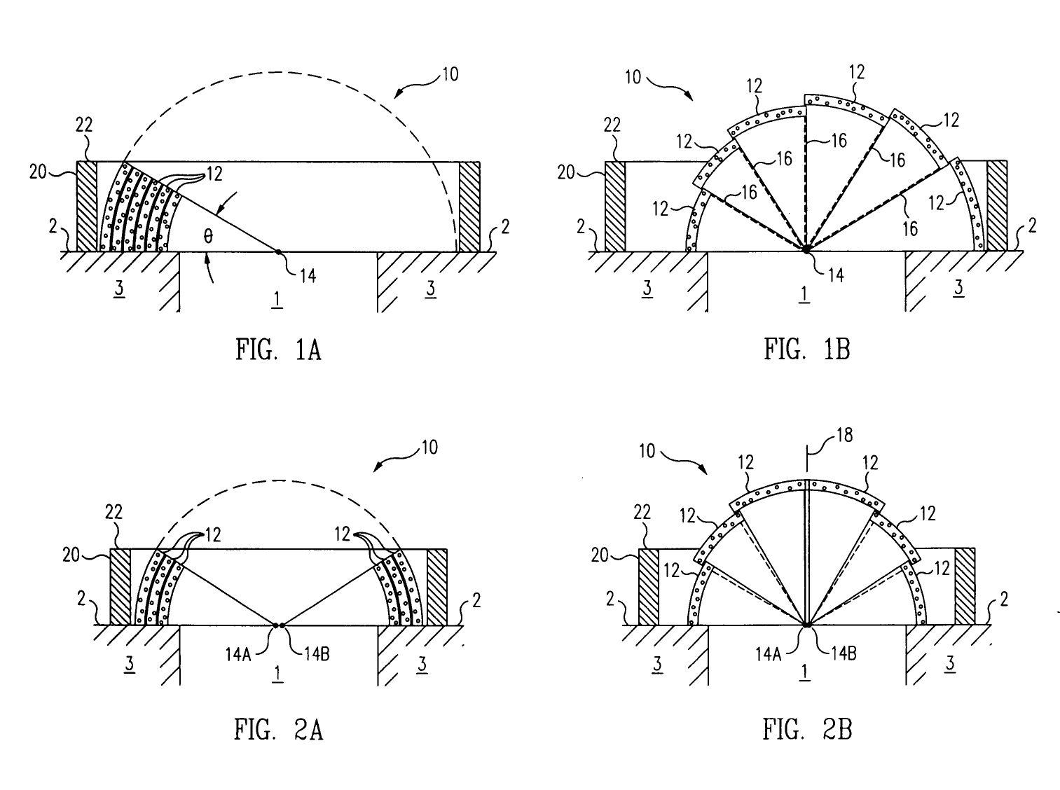

A first exemplary embodiment of a rigid, telescopically retractable protective dome 10 for protecting a feature 1 on an exterior surface 2 of a space vehicle 3 in accordance with the present invention is illustrated in FIGS. 1A and 1B in the retracted and deployed positions, respectively. As may be seen in FIG. 1A, in which the protective dome 10 is shown in the fully retracted position, the dome comprises a plurality of rigid, arcuate segments 12, each having opposite ends respectively pinioned at opposite sides of the feature 1 at about the surface 2 of the vehicle 3 for independent rotational movement of the segment about an axis of rotation 14 (seen end-on in the figures) extending through the two opposite ends thereof, and through an arcuate path of revolution extending over the feature, as indicated by the arcuate dashed line in FIG. 1A.

In the particular telescoping dome 10 embodiments illustrated in the figures, each of the arcuate segments 12 comprises a segment of one of a plurality of radially nested spheres that are subtended by a common angle θ (see FIG. 1A) extending from the axis of rotation 14 thereof, thereby resulting in protective domes 10 that are generally hemispherical in configuration when fully deployed, and hence, exhibiting a minimum surface area of dome for a given volume enclosed thereby. However, as will be appreciated by those of skill in the art, it is not necessary that each of the respective segments be subtended by a common angle θ, so long as the segments generally nest radially within each other when the dome is in the retracted position, and the dome generally provides the degree of coverage desired over the feature 1 to be protected when it is deployed. Additionally, other generally arcuate segment shapes are possible and may be used for the protective domes of the present invention, e.g., polygonal or ellipsoidal, depending on the particular application at hand.

The generally arcuate segments 12 of the rigid, telescoping dome 10 illustrated have respective radii 16 that are staggered in size such that, in a fully deployed position of the dome, as illustrated in FIG. 2B, in which adjacent segments are rotated apart from each other at a maximum relative angle therebetween, which is slightly less than the common angle 0 by which the respective segments are subtended, the segments overlap slightly at their radial and circumferential edges, and thereby combine to define a generally hemispherical shield over the protected feature 1. In the fully retracted position of the dome, as illustrated in FIG. 1A, in which adjacent segments are rotated together at a common angle θ relative to the surface 2 of the vehicle 3, the segments are nested in radial alignment with each other.

An alternative, “bi-fold” embodiment of a telescoping rigid protective dome 10 is illustrated in FIGS. 2A and 2B in the retracted and deployed positions, respectively. The spherical segments 12 of this embodiment, in addition to having respective radii 16 that are staggered in size, are provided in an even number, with half of the segments being grouped on one side of the protected feature 1, and the other half being grouped on an opposite side thereof. During full deployment of the protective dome 10, a segment of each of the two bilateral groups of spherical segments mate with each other at a sagital, or vertical plane 18 extending through the feature, as illustrated in FIG. 2B, to form a generally hemispherical shield over the feature. To facilitate this planar engagement of the two segments, it may be desirable to pinion the respective opposite ends of the segments of each of the two groups about two parallel, adjacent axes of rotation 14A and 14B, respectively. Alternatively, the outermost segment of one group of the segments can be made slightly larger than the outermost segment of the opposite group, such that the two portions of the dome overlap each other slightly when the dome is fully deployed.

The various embodiments of the telescoping, rigid protective domes 10 of the present invention may further advantageously comprise an annular protective bezel 20 having an internal diameter larger than the diameter of any of the spherical segments of the dome, which is disposed on the surface 2 of the vehicle 3 and aligned generally concentrically with the feature 1 protected by the dome, as illustrated in FIGS. 1A-2B. The height of the bezel is selected such the arcuate segments 12 all reside below an upper periphery 22 of the bezel when the dome is fully retracted, so that the bezel functions to protect the components of the retracted dome from traffic on the surface of the vehicle adjacent to the feature.

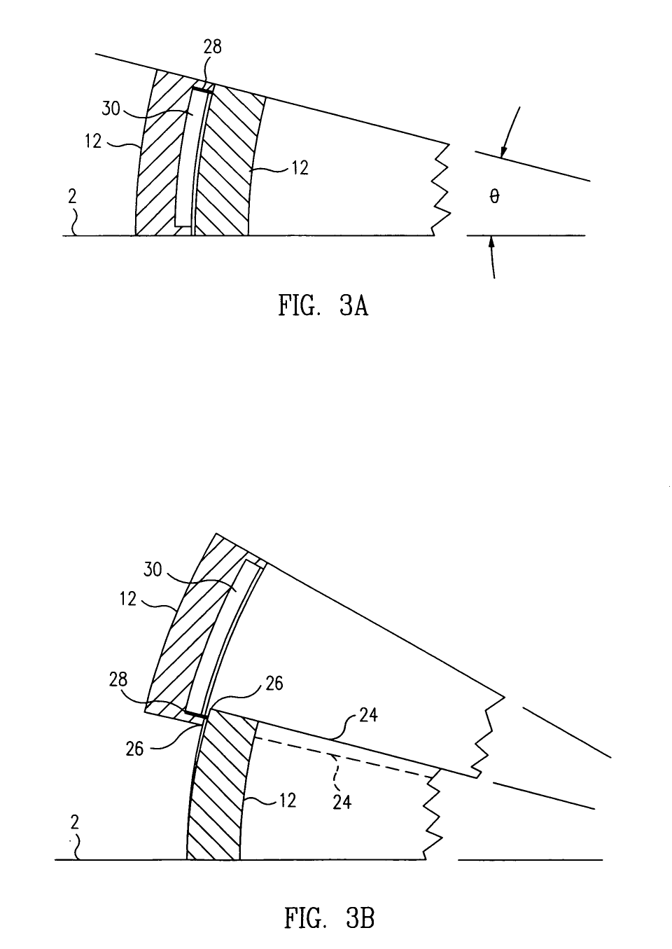

A partial cross-sectional view of two adjacent arcuate segments 12 of an exemplary embodiment of a rigid protective dome 10 in accordance with the present invention is illustrated in FIG. 3A, in which the segments are shown in the fully retracted position, i.e., rotated together at a common angle relative to the surface 2 of the vehicle 3, with the segments nested in radial alignment with each other. In FIG. 3B, the two segments are shown in the fully deployed position, i.e., rotated apart from each other at a maximum relative angle therebetween, such that their radial and circumferential edges 24 and 26 overlap slightly to define a portion of a generally hemispherical shield. In the particular embodiment illustrated, a resilient thermal seal 28 on one of the segments slides in a corresponding groove 30 on the other segment, and is operable to thermally insulate the feature 1 from ambient space when the dome is disposed in the deployed position. However, other types and configurations of edge seals are known and may be used in the protective domes of the present invention.

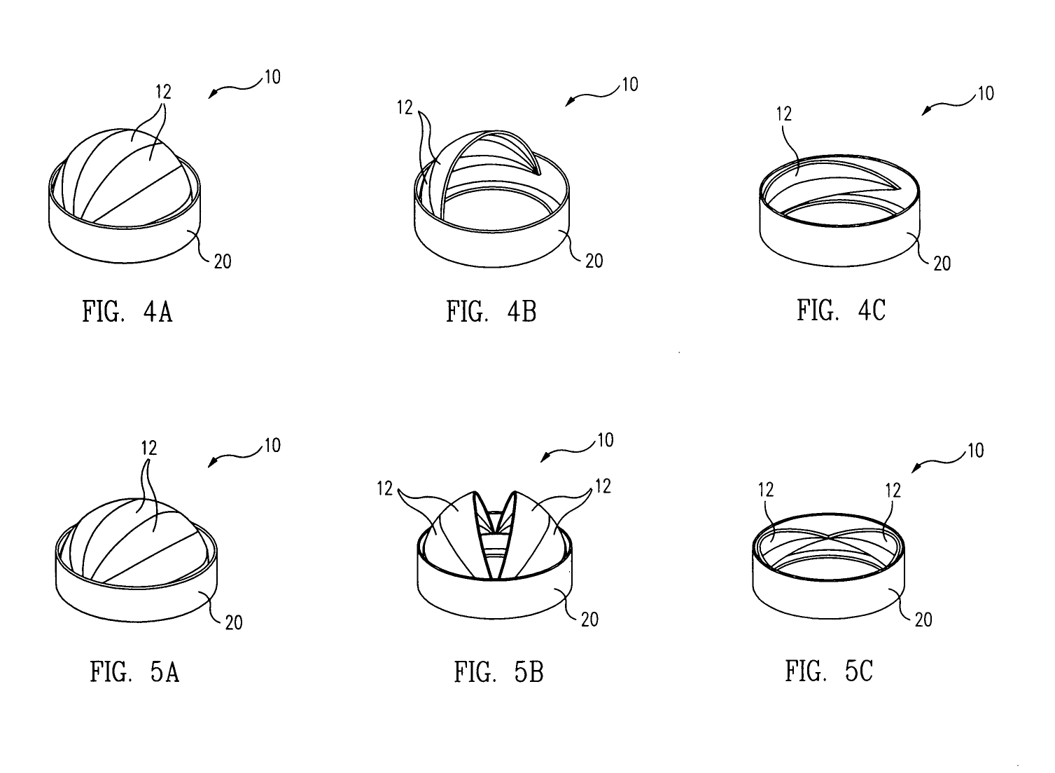

Perspective views of the protective dome 10 of FIGS. 1A and 1B disposed in a fully deployed, partially retracted, and fully retracted position, respectively, are illustrated in FIGS. 4A-4C. FIGS. 5A-5C are perspective views of the protective dome of FIGS. 2A and 2B disposed in the fully deployed, partially retracted, and fully retracted positions, respectively.

The rigid arcuate segments 12 of the telescoping protective domes 10 may be fabricated of a wide variety of materials, e.g., a metal or a composite, such as an epoxy resin, which may optionally be reinforced with a glass, metal or carbon-fiber mesh. Advantageously, the cover may be coated with or made to incorporate at least one of a thermal protection material and a micrometeoroid and orbital debris (“MMOD”) resistant barrier for shielding purposes.

By now, those of skill in this art will appreciate that many modifications, substitutions and variations can be made in and to the materials, apparatus, configurations and methods of implementation of the present invention without departing from its spirit and scope. Accordingly, the scope of the present invention should not be limited to the particular embodiments illustrated and described herein, as they are merely exemplary in nature, but rather, should be fully commensurate with that of the claims appended hereafter and their functional equivalents.

What is claimed is:

1. A retractable covering for protecting a feature disposed on a surface, wherein the covering comprises:
a plurality of arcuate segments, each having opposite ends respectively pinioned at opposite sides of the feature at about the surface for independent rotational movement of the segment about an axis of rotation extending through the opposite ends thereof and through an arcuate path of revolution extending over the feature, and a respective radial size arranged such that,
in a fully deployed position of the covering, in which adjacent segments are rotated apart at a maximum relative angle therebetween, the segments combine with each other to form an arcuate shield over the feature, and
in a fully retracted position of the covering, in which adjacent segments are rotated together at a common angle relative to the surface of the vehicle, the segments are nested in radial alignment with each other.

2. The covering of claim 1, wherein the segments comprise two groups, each defining a portion of the arcuate shield formed over the feature when the covering is fully deployed.

3. The covering of claim 2, wherein a segment of each of the two groups of segments mate with each other at a vertical plane extending through the feature when the covering is fully deployed.

4. The covering of claim 3, wherein there are an even number of segments, and wherein half of the segments are grouped on one side of the feature, and the other half are grouped on an opposite side thereof.

5. The covering of claim 4, wherein the respective segments of each of the two groups are respectively pinioned about two parallel, adjacent axes of rotation.

6. The covering of claim 1, further comprising a protective bezel having an internal diameter larger than any of the segments, disposed on the surface and aligned generally concentrically with the feature.

7. The covering of claim 6, wherein the segments reside below an upper periphery of the bezel when the covering is fully retracted.

8. The covering of claim 1, further comprising a seal disposed between adjacent segments and operable to seal the feature from ambient space when the covering is deployed.

9. The covering of claim 1, wherein the segments comprise at least one of a thermal protection material and a micrometeoroid and orbital debris resistant material.

10. The covering of claim 1, wherein each of the arcuate segments comprises a segment of one of a plurality of radially nested spheres that are subtended by a common angle extending from the axis of rotation thereof.

11. A retractable covering for protecting a feature disposed on a surface of a vehicle, wherein the covering comprises:
a plurality of semicircular, spherical segments, each having opposite ends respectively pinioned at opposite sides of the feature at about the surface of the vehicle for independent rotational movement of the segment about an axis of rotation extending through the opposite ends thereof and through a hemispherical path of revolution extending over the feature, and a respective radius that is sized such that,
in a fully deployed position of the covering, in which adjacent segments are rotated apart at a maximum relative angle therebetween, the segments combine with each other to form a generally hemispherical shield over the feature, and
in a fully retracted position of the covering, in which adjacent segments are rotated together at a common angle relative to the surface of the vehicle, the segments are nested in radially alignment with each other.

12. The covering of claim 11, wherein the segments comprise two groups, each defining a portion of the generally hemispherical shield formed over the feature when the covering is fully deployed.

13. The covering of claim 12, wherein a segment of each of the two groups of segments mate with each other at a vertical plane extending through the feature when the covering is fully deployed.

14. The covering of claim 13, wherein there are an even number of segments, and wherein half of the segments are grouped on one side of the feature, and the other half are grouped on an opposite side thereof.

15. The covering of claim 14, wherein the respective segments of each of the two groups are respectively pinioned about two parallel, adjacent axes of rotation.

16. The covering of claim 11, further comprising an annular bezel having an internal radius larger than the radius of any of the segments, disposed on the surface of the vehicle and aligned generally concentrically with the feature.

17. The covering of claim 16, wherein the segments reside below an upper periphery of the bezel when the covering is fully retracted.

18. The covering of claim 11, further comprising a seal disposed between adjacent segments and operable to seal the feature from ambient space when the covering is deployed.

19. The covering of claim 11, wherein the segments comprise at least one of a thermal protection material and a micrometeoroid and debris resistant material.

20. A method for protecting a feature disposed on a surface of a vehicle, the method comprising:
attaching respective opposite ends of a plurality of rigid, generally arcuate segments to pivot points respectively disposed on opposite sides of the feature; and,
pivoting the segments about the pivot points such that,
in a closed position, the segments overlap at edges to form a generally arcuate protective covering over the feature, and
in an open position, the segments nest in radial alignment with each other at the surface of the vehicle to expose the feature.

21. The method of claim 20, wherein attaching the segments to common pivot points comprises:
providing two groups of the segments; and,
attaching the opposite ends of the respective segments of each group about respective ones of a pair of pivot points disposed adjacent to each other on opposite sides of the feature such that,
a segment of each of the two groups of segments engages a segment of the other group at a vertical plane extending through the feature when the segments are in the closed position, and
the segments of each group respectively nest in radial alignment with each other at the surface of the vehicle and on opposite sides of the feature when the segments are in the open position.

22. The method of claim 20, further comprising:
sealing the overlapping edges of the segments when the segments are in the closed position.
